(19) United States
(12) Patent Application Publication
(10) Pub. No.: US 2018/0295087 A1
(43) Pub. Date: Oct. 11, 2018

(54) System and Method to Facilitate Information Exchange

(71) Applicant: RIVS.COM, Inc., Chicago, IL (US)

(72) Inventors: Brandon Bookatz, Chicago, IL (US); Dominik Kondrat, Chicago, IL (US); Phil Leslie, Park Ridge, IL (US); Henry Winn, St. Louis, MO (US)

(21) Appl. No.: 15/948,526

(22) Filed: Apr. 9, 2018

Related U.S. Application Data
(60) Provisional application No. 62/483,774, filed on Apr. 10, 2017.

(51) Int. Cl. H04L 12/58; H04L 29/08; H04L 29/12; G06Q 10/10; G06F 17/30

(52) U.S. Cl. CPC H04L 51/18; H04L 67/02; G06F 17/30345; H04L 51/10; G06Q 10/1053; H04L 61/307

(57) ABSTRACT

A system and method to facilitate information exchange between a first computer, a first data source operating on a second computer, and a second data source operating on a third computer are disclosed. A browser operating on the first computer receives, from the first data source, data that encodes information to render on the first computer in a first graphical window. The extension also operating on the first computer automatically parses the data to extract an electronic mail address from the data and displays the electronic mail address in a second graphical window on the first computer. In addition, the extension sends the electronic mail address to the second data source, wherein the second and third computers do not directly communicate with one another.

### CROSS REFERENCE TO RELATED APPLICATIONS

The present application claims benefit of Bookatz, et al., U.S. Provisional Application Ser. No. 62/483,774, filed Apr. 10, 2017, entitled “System and Method to Facilitate Information Exchange” (Attorney Docket No. C0554/40850). The entire contents of this application are incorporated herein by reference.

### FIELD OF DISCLOSURE

The present subject matter relates to information exchange between unaffiliated application servers, in particular using a browser extension to facilitate such exchange.

### BACKGROUND

Applicant Tracking Systems (ATSs) have been developed to assist a hiring manager or a human resources professional track information and status regarding candidates for employment. Such ATSs systems store contact information regarding the candidate including a full name, mailing address, e-mail address, telephone number and the like. These systems may also track, for example, one or more employment requisition or positions in which the candidate has shown an interest, whether the candidate has submitted an application and/or a resume, whether and how many times the candidate has been contacted, whether the candidate has been contacted for an in person or electronic interview and, if so, when such interview took place.

Electronic interviewing systems (EISs) have also been developed that facilitate standardized communications between an employer seeking employees and candidates. Such EISs allow the employer to define an interview workflow for a particular open requisition, and implement the interview workflow to evaluate each candidate for the requisition. The interview workflow may include the number of interviews the candidate will have to undertake, and for each interview, whether the interview will be text-based, a video interview, or a two-way interview between a representative of the employer and the candidate and one or more questions to which the candidate will be asked to respond. In a text-based interview the electronic interviewing system sends questions to the candidate either via e-mail or in a web browser, and the candidate supplies textual responses to each question. In a video interview, the EIS presents a question to the candidate in a web browser and allows the candidate to record a video response to the question. Alternately, the questions may be sent to the candidate and the candidate may be asked to upload to the EIS a video with responses to such questions. In the two-way interview, a video and/or text chat session, a telephone call, or an in-person meeting between the representative and the candidate is used to enable the representative to interview the candidate. The responses from the candidate are provided to the hiring manager or human resources professional for evaluation.

The hiring manager or human resources professional typically interacts with both the ATS and EIS using a web browser based graphical user interface (GUI). However, the ATS and EIS used by the hiring manager or human resources professional may be provided by different developers, and thus may operate as separate web applications, which may be operated from different web servers. The web servers in which the ATS and EIS may be co-located or be remote from one another. In such cases, because the ATS and EIS are not interconnected, the hiring manager or human resources professional may have to manually enter identical information about candidates in both the ATS and EIS.

### SUMMARY

According to one aspect, a system to facilitate information exchange between a first computer, a first data source operating on a second computer, and a second data source operating on a third computer includes a browser and an extension associated with the browser, both operating on the first computer. The browser receives, from the first data source, data that encodes information to render on the first computer in a first graphical window. The extension automatically parses the data to extract an electronic mail address from the data and displays the electronic mail address in a second graphical window on the first computer. In addition, the extension sends the electronic mail address to the second data source, wherein the second and third computers do not directly communicate with one another.

According to another aspect a method to facilitate information exchange between a first computer, a first data source operating on a second computer, and a second data source operating on a third computer includes the steps of receiving at the first computer, from the first data source, data that encodes information to render on the first computer in a first graphical window, automatically parsing the data by the first computer to extract an electronic mail address from the data, displaying the electronic mail address in a second graphical window on the first computer, and sending the electronic mail address to the second data source. The first data source and the second data source operate on computers that do not directly communicate with one another.

### BRIEF DESCRIPTION OF THE DRAWINGS

FIG. 1 is a block diagram of a system to facilitate candidate information between an Applicant Tracking System and an Electronic Interviewing System;

FIG. 2 is a graphical user interface of the Applicant Tracking System of FIG. 1 with which the system of FIG. 1 operates;

FIG. 3 is a graphical user interface associated with an extension that facilitates communications between the ATS and EIS of the of the system of FIG. 1;

FIG. 4 is dialog box of the graphical user interface of the system of FIG. 1 to create a new requisition including creating a set of interview questions;

FIG. 5 is a dialog box of the graphical user interface of the system of FIG. 1 to specify an interview type;

FIGS. 6 and 7 are a dialog box of the graphical user interface of the system of FIG. 1 that shows updated candidate status information

FIG. 8 is a dialog box of the graphical user interface of the system of FIG. 1 in which a video response from a candidate may be viewed;

FIG. 9 is a graphical user interface of the Electronic Interviewing System with which the system of FIG. 1 operates;

FIG. 10 is dialog box of the graphical user interface of the system of FIG. 1 that shows additional candidate information;

FIG. 11 is a flowchart of steps undertaken by the system of FIG. 1 to extract e-mail addresses and other information from the graphical user interface of FIG. 2;

FIG. 12 is a flowchart of steps undertaken by the system of FIG. 1 to receive updated status information of candidates; and

FIG. 13 is a flowchart of steps undertaken by the system of FIG. 1 to send an interview request to selected candidates.

### DETAILED DESCRIPTION

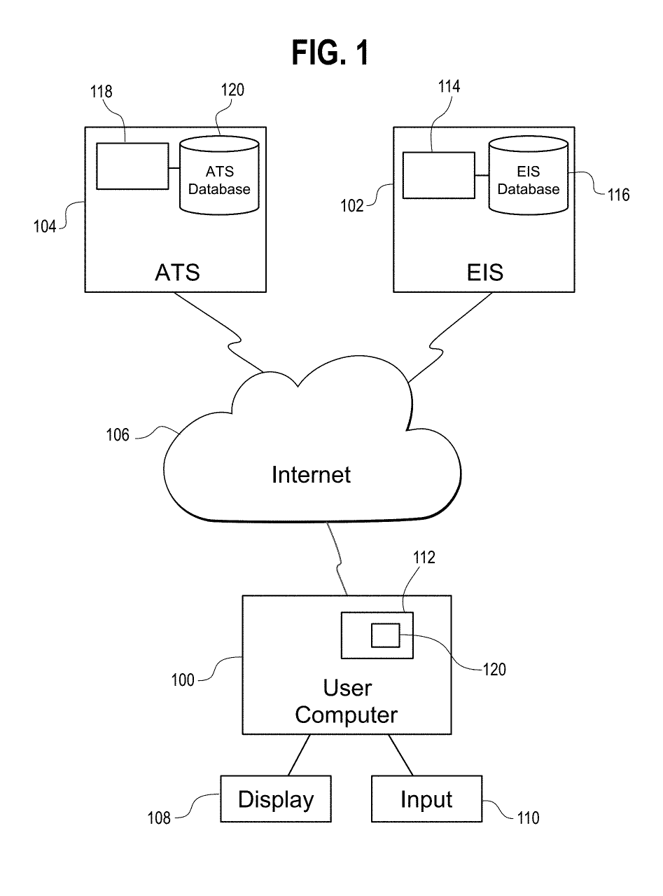

A system and method are disclosed herein to facilitate the exchange of candidate information between an ATS and EIS, and thus reduce duplicate entry of information by a user (e.g., a hiring manager, a human resource professional, and the like) into such systems. Referring to FIG. 1, a computer 100 used by the user connects to an EIS 102 and an ATS 104 over a network 106. The network 106 may include be a wide area network, for example, the Internet, a virtual private network implemented on a wide area network, a local area network, and the like.

The computer 100 includes a display 108 and an input device 110. The input device 110 may include one or more of a keyboard, a mouse, a trackpad, a touch screen, and the like.

During operation, the user configures the EIS 102 with one or more open employee requisitions (i.e., open employment positions), and the interview workflow for each such requisition. In particular, the user operates a web browser 112 on the computer 100 to connect to an EIS web server 114 operating on the EIS 102. For example, the user may, using the input device 110, enter a Uniform Resource Locator (URL) associated with the EIS 102 into the web browser 112. In response, the EIS web server 114 generates and transmits to the computer 100 web content to render on the display 108.

Such web content comprises rendering code encoded in Hypertext Markup Language (HTML), and resources used by the rendering code including one or more image files, one or more Cascading Style Sheets (CSS), and one or more scripts such as functions in the JavaScript language, applets encoded in Java. When interpreted by the browser 112, the HTML and the resources cause the browser 112 to render an EIS graphical user interface (GUI) on the display 108 and that accepts input from the input device 110.

The EIS GUI operating in the browser 112 allows the user to use the input device 110 to enter information about the open requisition including, for example, an identifier (e.g., a job title), the number of interviews a candidate will undertake when being considered for the open requisition, the type of each interview (e.g., electronic text based, one-way video, or a two-way video, two-way in person, etc.), and the like. If the type of interview is electronic, the user also specifies if the interview is text based (e.g., where the candidate submits textual answers on electronic form, by e-mail, and the like) or if the interview is a video-interview. For an electronic interview, the user also configures one or more questions the candidate will be asked to answer. After such information is entered, the open employment requisition information is stored in an entry in an EIS a database 116 associated with the EIS 102.

In some embodiments, the user may also use the EIS GUI displayed by the web browser 112 to select a previously entered open requisition and mark such requisition as filled (i.e., the employment position is no longer available or open). Similarly, the user may also use the EIS GUI to select a previously entered requisition that was marked filled and mark such requisition as open.

After the EIS database 116 has been populated with information about the open requisition, the user may use the EIS GUI to enter information about a candidate into the EIS database 116, and direct the EIS to contact the candidate for an interview associated with the open requisition. In response, if the interview is an electronic interview, the EIS 102 sends an e-mail or otherwise electronically contacts the candidate for an interview. If the candidate expresses interest, the EIS 102 sends the interview questions to the candidate. As described above, the candidate may provide a text or a video response to each question. Such responses are received by the EIS 102 from the candidate (for example, the candidate may e-mail such responses to a particular e-mail address associated with the EIS 102, may complete a form provided on web page generated by the web server 114 of the EIS, may use such form to upload a video or audio response, and the like). The received response is stored and the entry in the EIS database 116 associated with the requisition is updated to include information regarding the candidate who supplied the interview response and the contents of the interview response.

The user also enters information about potential candidates into the ATS 104 using the computer 100. In particular, the user operates the web browser 112 on the computer 100 to connect to an ATS web server 118 operating on the ATS 104. For example, the user may, using the input device 110, enter a Uniform Resource Locator (URL) associated with the ATS 104 into the web browser 112. In response, the web server 118 generates and transmits to the computer 100 web content to render an ATS graphical user interface (GUI) on the display 108.

As described above, such web content includes HTML and other resources associated with the ATS GUI that when interpreted by the browser 112, cause the browser 112 to render an ATS GUI web page on the display 108 and accepts input for the ATS 104 from the input device 110. The ATS GUI operating in the browser 112 allows the user to use the input device 110 to enter information about potential candidates including a name, contact information, credentials of the candidate, and the like. The contact information may include one or more of a physical address, an e-mail address, a telephone number, and the like. Typically, the ATS GUI operating in the browser 112 receives from the user new or updated information associated with a candidate, and generates a request to the ATS 104 to enter/update such information in an entry associated with the candidate in an ATS database 119.

Similarly, the ATS GUI operating in the browser 112 allows the user to enter using the input device 110 search terms with which to query the ATS 104 for information associated with one or more candidates previously stored in the ATS database 119. In response, the ATS GUI generates and sends a request to the ATS 104 associated with the query. Thereafter, the ATS 104 retrieves from the ATS database 119 one or more entries associated with candidates that satisfy the query, and provides information from entries to the browser for rendering on the display 108.

In some embodiments, the ATS web server 104 provides retrieved information encoded in HTML. Alternately, the ATS 104 web server may encode the information from the retrieved entries in accordance with XML, JSON or other similar technologies, transmit the encoded information to the user computer 100, where a script (for example, a JavaScript) that is part of the ATS GUI web content interprets and renders the encoded information on the display 108.

A web browser extension 120 operates in the context of the web browser 112 on the computer 100 to allow the user to easily update candidate information in the EIS database 116 with information shown in the ATS GUI in the browser 112. Such web browser extension 120 is developed in accordance with guidelines published by developers of the web browser 112 used to implement the functionality of the ATS GUI 112. Typically, the extension includes a manifest or description file, and one or more resource files such as HTML, JavaScript, CSS, image files.

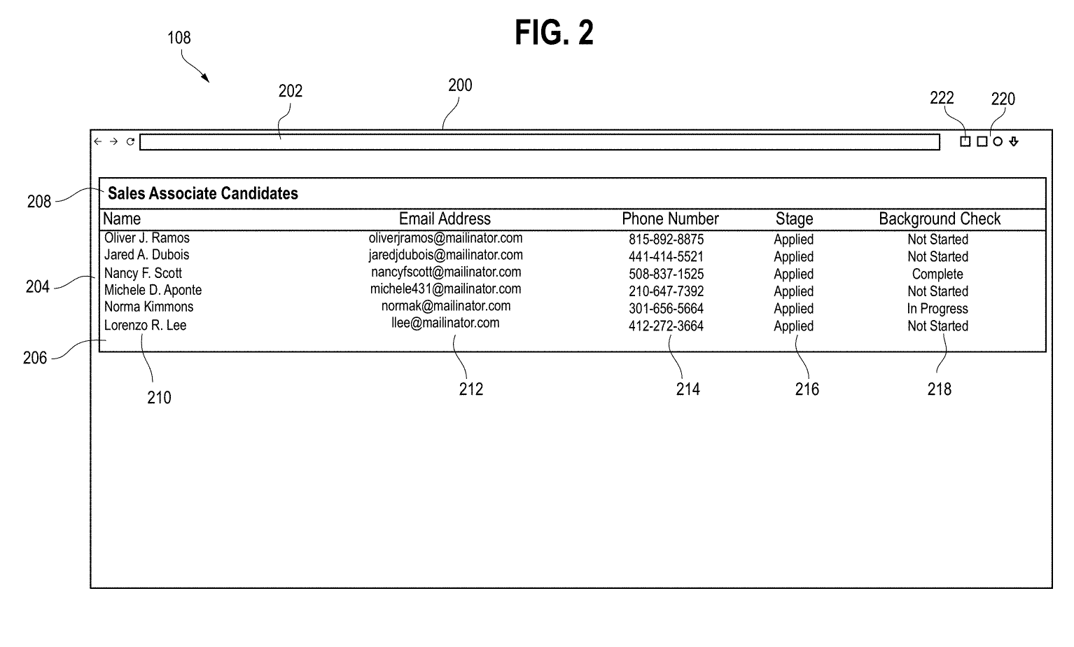

Referring to FIGS. 1 and 2, the web browser 112 operating on the computer 100 displays a window 200 associated therewith on the display 108. As should be apparent to those who have skill in the art, the window 200 generated by the web browser 112 includes an input region 202 in which a URL may be entered and a content region 204. The content displayed in the content region 204 is typically associated with and generated in response to the URL entered in the input region 202.

In response to a query submitted to the ATS 104, the web browser 112 renders an ATS GUI 206 in the content region 204. In particular, the user may have previously submitted to the ATS 104 via, for example, a web form (not shown) to select a job-title associated with an open requisition and query terms to identify candidates who may be contacted to interview for such requisition. Such query terms may include characteristics such skills, education, and the like of candidates to contact. The ATS GUI 206 includes a text box 208 in the title associated with the particular requisition is displayed. The ATS GUI 206 also includes a column 210 in which names of potential candidates are listed identified in response to the query are displayed, and columns 212 and 214 in which an email address and telephone number, respectively, associated with each candidate listed in the column 210 are displayed. In addition, the ATS GUI 206 includes a column 216 that indicates whether a particular candidate listed in the column 210 has applied for the requisition shown in the text box 208, and a column 218 that indicates whether a background check (or other pre-defined process) has been initiated for the candidate.

The window 200 generated by the web browser 112 also includes a region 220 in which icons associated with extensions loaded into the web browser 112 are displayed, and in particular an icon 222 associated with the extension 120 is displayed.

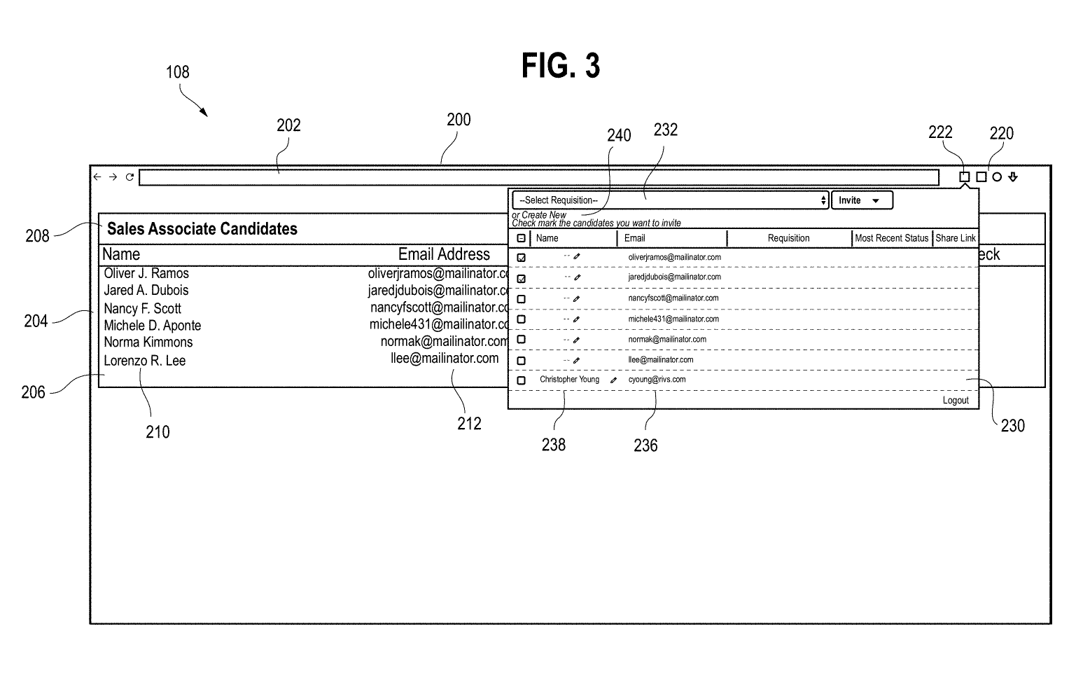

Referring to FIGS. 1 and 3, when the user selects the icon 222, the web browser 112 activates the extension 120. The extension 120 confirms that the user is authorized to use the EIS 102, for example, by checking whether a browser cookie associated with the EIS 102 has been registered with the web browser 112. Alternately, the extension 120 may display an authentication dialog box (not shown) that allows the user to enter authentication credentials, for example, a user name and a password associated with an account the user has previously registered with the EIS 102. The extension 120 transmits such credential information to the EIS 102 to authenticate that the user is authorized to use the extension 120 and the EIS 102.

After the extension 120 authenticates the user, the extension 120 generates and renders on the display 108 a candidate selection dialog box 230. The candidate selection dialog box 230 includes a requisition drop-down menu 232, an invite button 234, a column 236 with e-mail addresses of candidates displayed in the column 212 of the ATS GUI 206, and a column 238 with a selectable box associated with each candidate whose e-mail address is shown in the column 236.

If the user selects the pop-up menu 232, the extension 120 retrieves from the EIS 102 titles of open requisitions associated with the user. Alternately, the user may select a selectable text item or button 240 to create and submit a new requisition to the EIS 102.

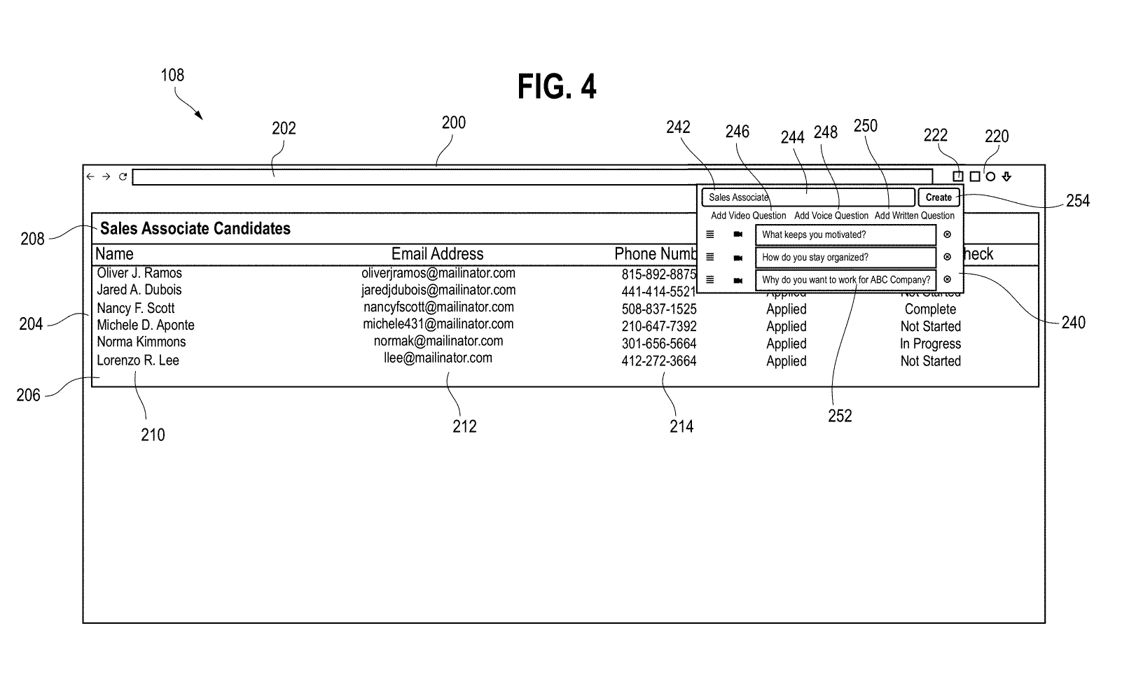

Referring to FIGS. 1, 3 and 4, when the button 240 is selected, the extension 120 generates and displays a create requisition dialog box 242. The create requisition dialog box 242 includes a text box 244 in which the user may enter a title of a new requisition. The create requisition dialog box 242 also includes selectable text items or buttons 246, 248, and 250 to enter one or more questions to which a candidate applying for the requisition may provide by a video, voice, or written response, respectively. If a user selects one these buttons 246, 248, or 250, a text box 252 is added to the dialog box 242 in which the user may enter a question. After the user has supplied a title and one or more questions associated with the new requisition, the user may select a button 254 to store the new requisition in the EIS 102. When the user selects the button 254, the extension 120 transmits a request to the EIS 102 to create and store in the EIS database 116 a new entry associated with the new requisition. Referring to FIGS. 1 and 3, after the new entry is created, the extension 120 once again displays the candidate selection dialog box 230 with the title of the newly created requisition available for selection using the drop-down menu 232. In some embodiments, the extension 120 automatically selects the new requisition in the drop-down menu 232.

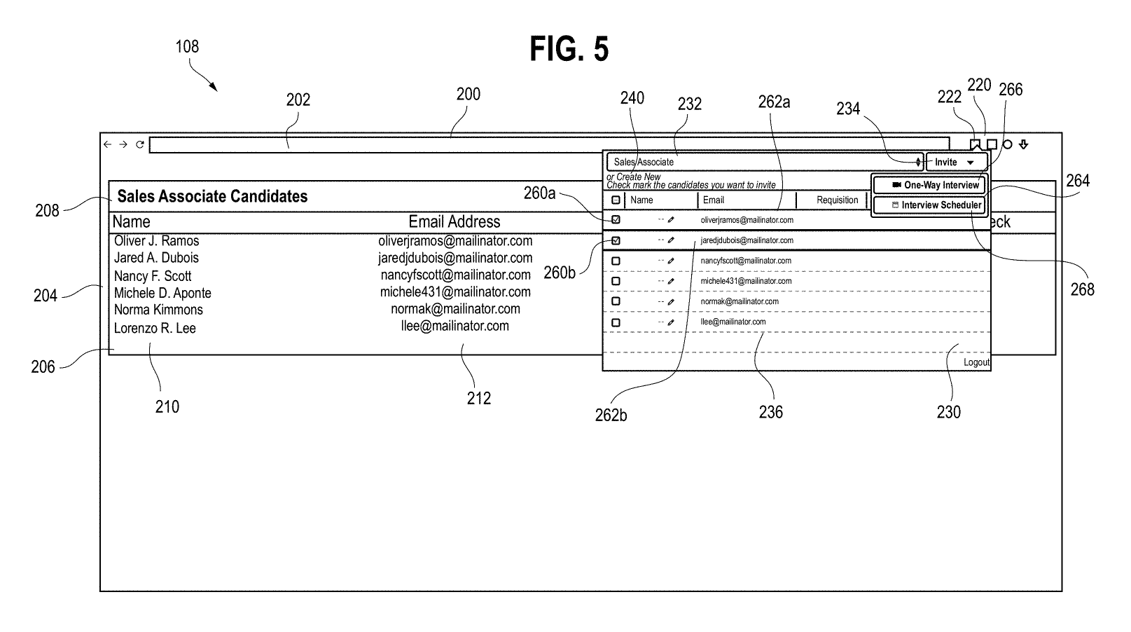

Referring to FIGS. 1 and 5, the user may select one or more check boxes 260a, 260b in the column 238 that correspond to candidates whose email addresses are shown rows 262a and 262b of the column 236. In some embodiments, if, after selecting the one or more check boxes 260, the user selects the button 234, the extension 120 displays a specify interview type dialog box 264 that includes a button 266 to request a one-way interview and a button 268 to request a two-way interview.

If the user selects the button 266, the extension 120 submits a request to the EIS 120 to generate and send an e-mail to each e-mail address associated with the check box 260 in the column 238 that has been selected by the user. In some embodiments, a separate request is generated and sent to the EIS 102 for each selected e-mail address. In other embodiments, a single request is generated and sent to the EIS 120 and the single request includes multiple e-mail addresses to which invitation are to be sent.

If the user selects the button 268, the extension 120 generates and submits a request to the EIS 120 to send the selected candidates an e-mail message to request a two-way interview, such as an in-person interview, a telephonic interview, a two-way video interview, and the like. In one embodiment, the e-mail includes a date and time when the user is available. Such date and time may be selected based on a calendar uploaded to the EIS 120 by the user.

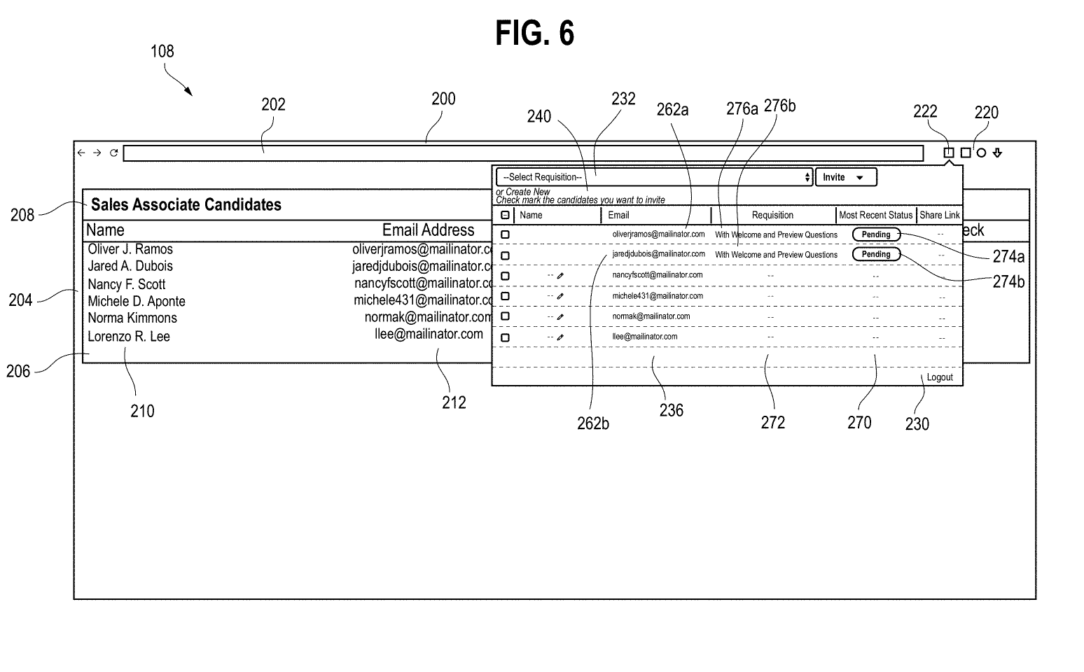

Referring to FIGS. 1 and 6, in some embodiments, the candidate selection dialog box includes a column 270 and 272 that provide the user with status information regarding messages sent to or information received from candidates. In particular, for each candidate whose e-mail address is displayed in the column 236, the extension 120 displays status indicator text 274a and 274b in the column 270 that shows whether an interview with such particular candidate is pending or completed. In addition, the extension 120 displays text 276a and 276b in the column 272 that indicates the name of the requisition for which status is provided in the column 270.

In particular, when the EIS 102 sends an interview request to a candidate or receives a response from the candidate, the EIS 102 records such information in the EIS database 116. When the extension 120 is active, the extension 120 periodically requests status information from the EIS 102 for each candidate whose e-mail address is displayed in the column 236 (and also in the column 212). For each such candidate, the EIS 102 queries the EIS database 116 for status information recorded in the record of the EIS 102 associated with such candidate, and returns the text (if any) that should be displayed in the rows of the column 270 and 272 associated the candidate.

As noted above, if a candidate responds to an interview request and submits, for example, one or more video responses to the interview questions, the EIS 102 updates the entry in the EIS 102 associated with candidate to note that the response has been received. In addition, the EIS 102 records in such entry a link to the video(s) submitted by the candidate.

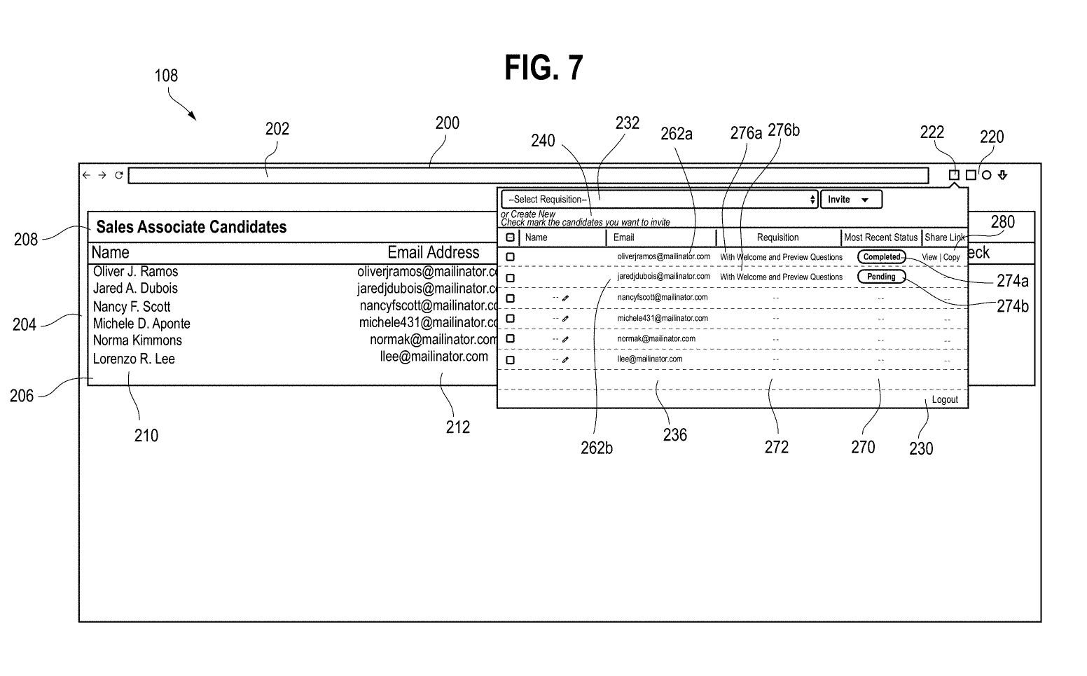

Referring to FIGS. 1 and 7, in some embodiments, when the extension 120 requests from the EIS 102 a status update for a candidate who has submitted a response to an interview request, the EIS 102 supplies the status information displayed in the columns 272 and 270 as noted above. In addition, if available, the EIS 102 supplies the link to the video submitted by the candidate. The extension 120 includes a column 278 in which such links may be made available to the user for viewing. In particular, the extension 120 provides a hyperlink in a row 280 of the column 278 associated with the email address of the candidate who submitted the response.

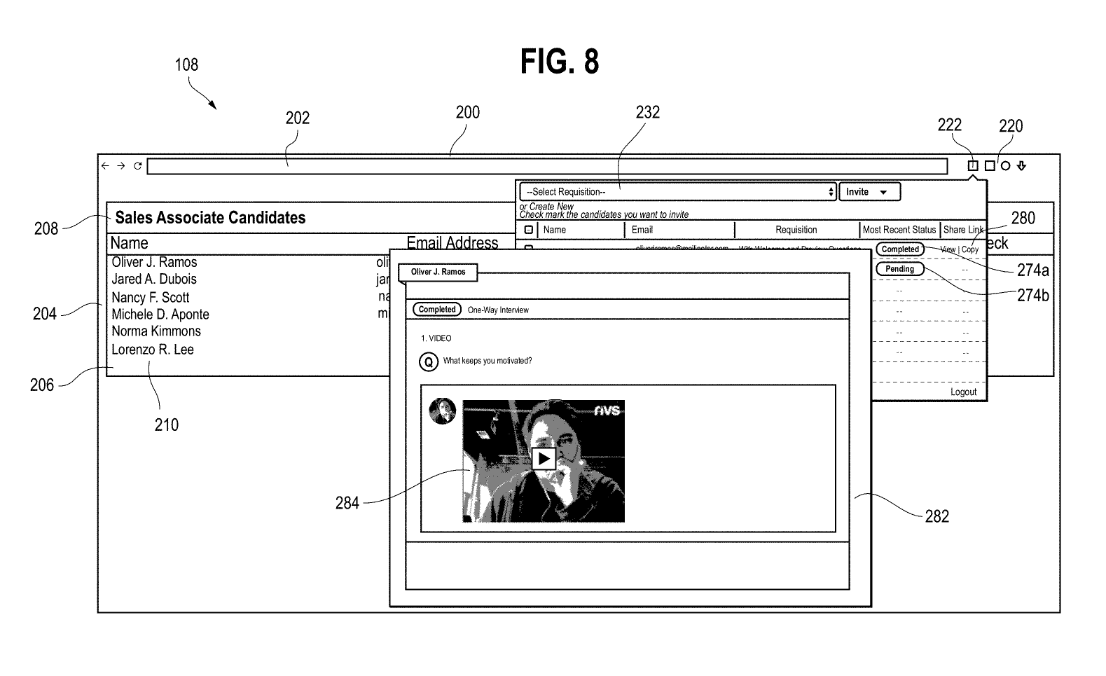

Referring also to FIG. 8, if the user selects the hyperlink in the row 280, the extension 120 displays a dialog box 282, and displays the video 284 submitted by the candidate in such dialog box 282.

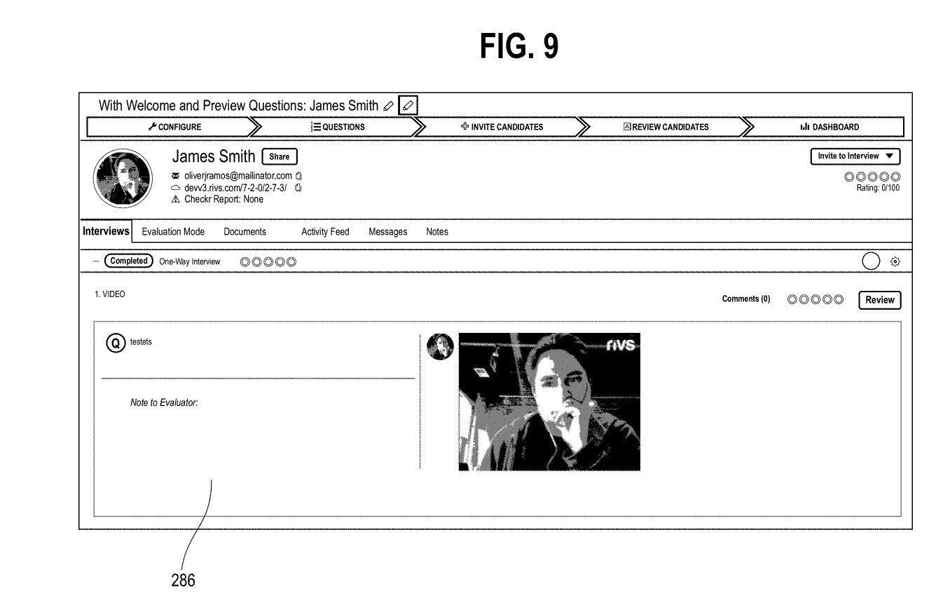

Referring to FIGS. 1, 7, and 9, in some embodiments, if the user selects an e-mail address 262 shown in the column 236 of the candidate selection dialog box 230, the extension 120 opens a browser window 286 loaded with the graphical user interface of the EIS 120. Information associated with the candidate whose e-mail was selected is displayed in such window 286. The user may then enter evaluations and other notes using such graphical user interface, and the EIS 102 stores such evaluations and/or notes in the entry of the EIS database 116 associated with the candidate.

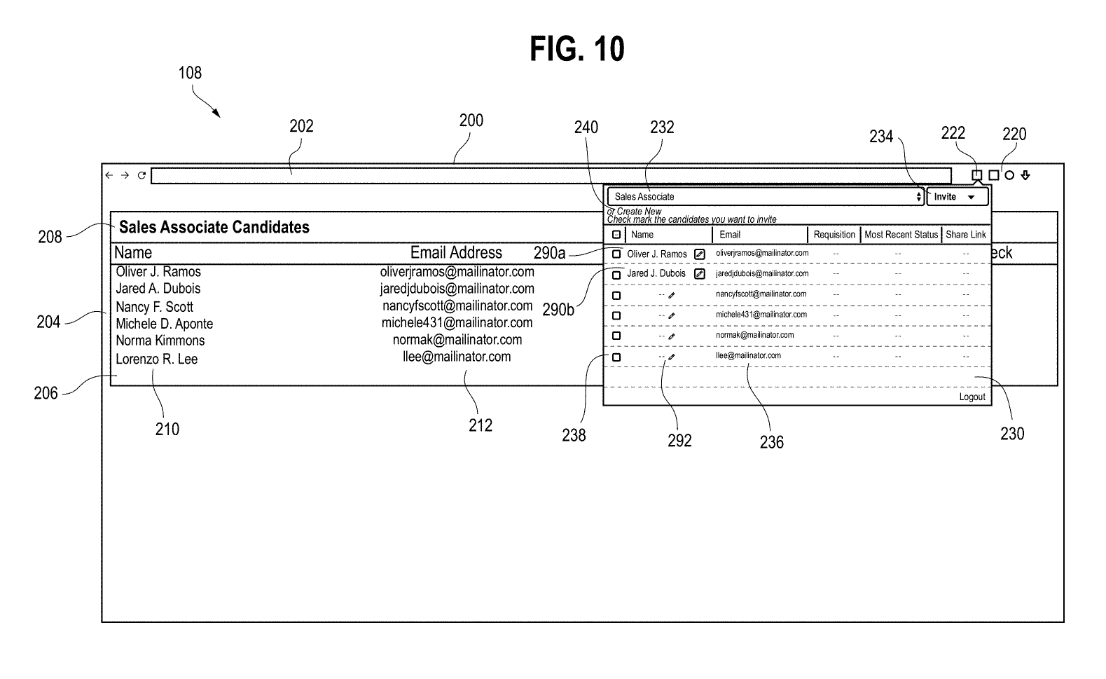

Referring to FIGS. 1, 2, and 10, in some embodiments, if the EIS database 116 includes an entry associated with a candidate whose e-mail is listed in the column 212 and such entry in the EIS database 116 includes the candidates name, the extension 120 requests such name from the EIS 102 when generating the candidate selection dialog box 230. Names of any candidates available from the EIS 102 in this manner are displayed as text 290a and 290b in rows of a column 292 of the dialog box 230.

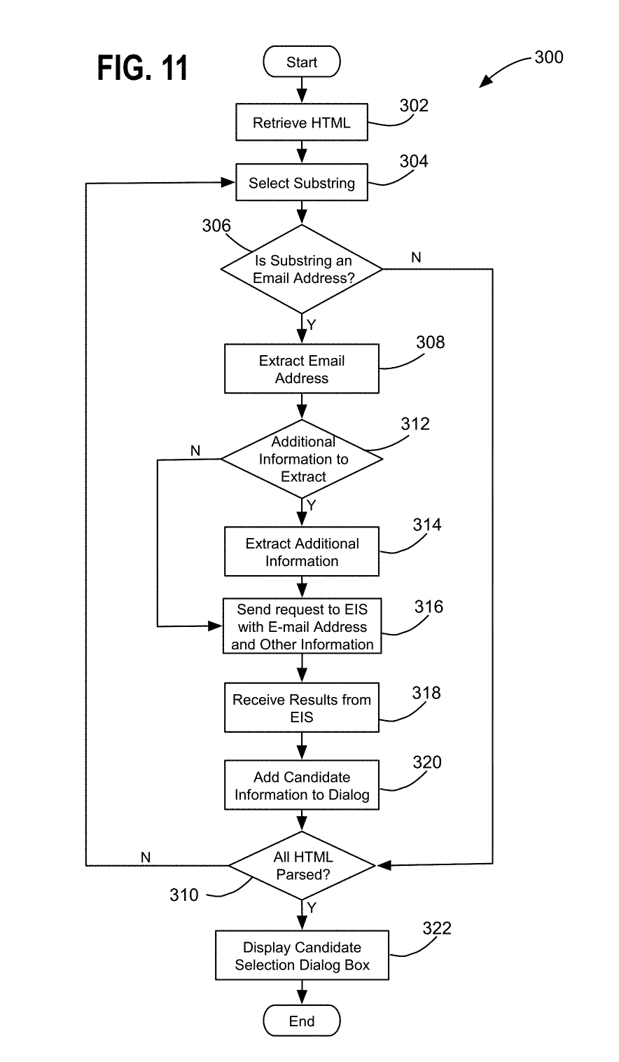

FIG. 11 is a flowchart 300 of the steps undertaken by the extension 120 (FIG. 1) to generate the candidate selection dialog box 230 (FIG. 3). Referring to FIGS. 1, 3, and 11, when the user selects the icon 222 associated with the extension 120, the extension 120 requests from the browser 112, the HTML code used to generate the ATS GUI 206 displayed in the window 200, at step 302.

At step 304, the extension 120 parses the text in the HTML code to extract a whitespace delimited substring encoded in the HTML. The extracted substring is a contiguous string of characters that is separated from adjacent contiguous strings of characters by one or more whitespace characters such as a space character, a newline character, a tab character, and the like.

At step 306, the extension 120 determines if the substring identified at step 204 matches a pattern associated with an e-mail address. In particular, the extension analyses the identified substring to confirms that the substring includes exactly one “at” (“@”) symbol that separates a prefix substring and a suffix substring. The extension, also at step 306, further confirms whether the prefix substring comprises only alphanumeric characters, and that the suffix substring matches a pattern associated with a domain name (i.e., the suffix substring comprises series of alphanumeric characters separated by a period character). The extension 120 may undertake further tests to confirm that the identified substring the pattern of an e-mail address.

If the identified substring matches the pattern of an e-mail address, the extension 120 proceeds to step 308. Otherwise, the extension 120 proceeds to step 310.

At step 308, the extension 120 extracts the e-mail address. Then, at step 312, the extension 120 checks whether additional information associated with the candidate may be extracted from the HTML. In one embodiment, the extension 120 determines if the HTML code generated by ATS 104 associated with the URL entered in the text box 202 (FIG. 3) facilitates extraction of additional information (e.g., a name, telephone number, and the like) about the candidate. If so, the extension 120 proceeds to step 314, otherwise the extension proceeds to step 316.

At step 314, the extension 120 further analyzes the HTML to extract any additional information. In some embodiments, the structure of the HTML generated by the ATS 104 may have been pre-analyzed to determine where in the HTML additional information that may be extracted by the extension 120 appears relative to the e-mail address. For example, such analysis may indicate that information associated with candidates is encoded in the HTML as a table, with one row for each candidate. Further, such analysis may indicate that the full-name of the candidate appears in such row in a field that immediately precedes the field in which the e-mail address is encoded. The extension 120 uses such structural information to extract the full-name of the candidate once the e-mail address for the candidate has been identified. It should be apparent that other types of structural information regarding the HTML produced by various ATS 104 may be analyzed to extract such information. Such structural information may be encoded in the extension 120 or provided to the extension 120 by the EIS 102 when the extension 120 is launched.

At step 316 generates and transmits a message to the EIS 102 to request that the EIS 102 create an entry in the EIS database 116 associated with the identified e-mail address, if such entry has not already been created. The message also includes any additional information regarding the candidate extracted from the HTML and a request that if the EIS database 116 already includes an entry associated with the e-mail address, the EIS 102 verify any additional information sent thereto in the message, and transmits to the extension 120 a validated name, if any, recorded in such entry.

At step 318, the extension 120 receives from the EIS 102 a message that confirms that the e-mail address has been added to the EIS database 116 and, if available, includes a name of the candidate associated with the e-mail address.

At step 320, the extension 120 adds the e-mail address and the name of the candidate associated with such e-mail address to the candidate selection dialog box 230.

At step 310, the extension determines if all of the substrings in the HTML code have been identified and analyzed as described above. If so, the extension proceeds to step 322, otherwise the extension returns to step 304 to select another substring from the HTML code.

At step 322, the extension 120 displays the candidate selection dialog box 230 with the e-mail addresses identified as described above.

In another embodiment, the extension 120 may include different types of scanners, each scanner designed to extract a particular type of candidate information. Such scanner may have structural information regarding the ATS 104 encoded therein or provided thereto as described above. There may be, for example, a scanner to extract e-mail addresses, another scanner to extract candidate names, and so on. When the extension 120 is launched, the extension 120 determines which scanners are able to operate on HTML generated by the ATS 104, and then calls each scanner sequentially to extract candidate information from the HTML. It should be apparent that other ways of extracting candidate e-mail addresses and other candidate information known to those who have skill in the art may be used.

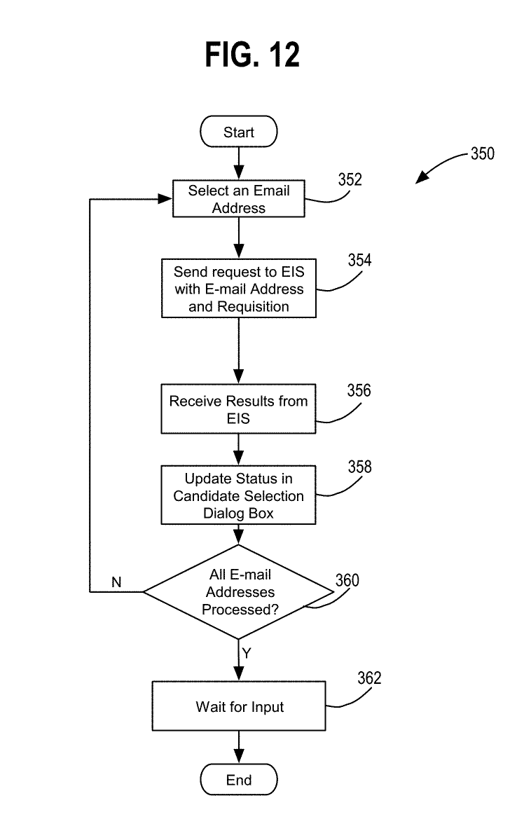

FIG. 12 is a flowchart 350 of the steps undertaken by the extension 120 (FIG. 1) when the user selects a requisition from the drop-down menu 232. Referring to FIGS. 1, 3, 7, and 12, at step 352 the extension 120 selects an e-mail address shown in the candidate selection dialog box 230. At step 354, the extension 120 generates and transmits a message to the EIS 102 to request status information associated with the selected e-mail address and the selected requisition. The EIS 102 queries the EIS database 116 to determine if any invitation has been sent to the e-mail address asking the candidate associated therewith to interview for the selected requisition and/or if any response has been received from such candidate. The EIS 102 generates and sends a message to the extension 120 such status information.

At step 356, the extension 120 receives from the EIS 102 the message with the status information, and at step 358, the extension 120 updates columns 270, 272, and 278 (FIG. 8) of the candidate selection dialog box 230 with such status information as described above.

At step 360, the extension 120 determines a status request message has been sent in connection with all the e-mail addresses displayed in the candidate selection dialog box 230. If any e-mail addresses remain, the extension proceeds to step 352 to select another e-mail address. Otherwise, the extension 120 waits for an input from the user, at step 362.

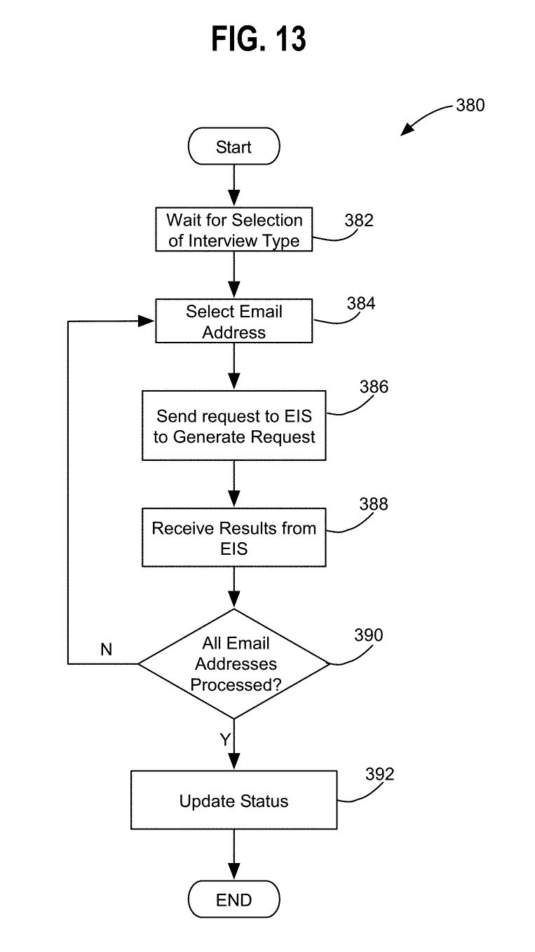

FIG. 13 is a flowchart 380 of the steps undertaken by the extension 120 (FIG. 1) when the user selects the invite button 234 (FIG. 5) after selecting the check boxes in 260 in the candidate selection dialog box 230. In a preferred embodiment, the invite button 234 is only activated for selection after the user selects a requisition from the drop-down menu 232 and at least one check box 260.

At step 382, the extension 120 displays the interview type dialog box 264 and waits for a selection of an interview type therefrom. At step 384, the extension 120 selects an e-mail address associated with a box 260 that has been selected. At step 386, the extension 120 generates and sends to the EIS 102 a message to send an e-mail message to the selected e-mail address that includes an invitation to interview for the requisition selected from the drop-down menu 232, and with the interview type selected from the interview type dialog box 264.

At step 388, the extension 120 waits to receive confirmation that the EIS 102 received and processed the message. At step 390, the extension 120 determines if all e-mail addresses that are associated with a selected box 260 have been processed. If any such e-mail addresses remain, the extension 120 proceeds to step 384 to select another e-mail address. Otherwise, at step 392, the extension 120 updates the status of the e-mail addresses displayed in a candidate selection dialog box 230, for example, by undertaking the steps of the flowchart 350 (FIG. 13).

It should be apparent to those who have skill in the art that any combination of hardware and/or software may be used to implement system and method to facilitate exchange of information between the EIS 102 and the ATS 104. It will be understood and appreciated that one or more of the processes, sub-processes, and process steps described in connection with FIGS. 1-13 may be performed by hardware, software, or a combination of hardware and software on one or more electronic or digitally-controlled devices. The software may reside in a software memory (not shown) in a suitable electronic processing component or system such as, for example, one or more of the functional systems, browser extensions, controllers, devices, components, modules, or sub-modules schematically depicted in FIGS. 1-13. The software memory may include an ordered listing of executable instructions for implementing logical functions (that is, “logic” that may be implemented in digital form such as digital circuitry or source code, or in analog form such as analog source such as an analog electrical, sound, or video signal). The instructions may be executed within a processing module or controller (e.g., the user computer 100, the EIS 102, and the ATS 104), which includes, for example, one or more microprocessors, general purpose processors, combinations of processors, digital signal processors (DSPs), field programmable gate arrays (FPGAs), or application-specific integrated circuits (ASICs). Further, the schematic diagrams describe a logical division of functions having physical (hardware and/or software) implementations that are not limited by architecture or the physical layout of the functions. The example systems described in this application may be implemented in a variety of configurations and operate as hardware/software components in a single hardware/software unit, or in separate hardware/software units.

The executable instructions of the browser extension 120 may be implemented as a computer program product having instructions stored therein which, when executed by a processing module of an electronic system, direct the electronic system to carry out the instructions. The computer program product may be selectively embodied in any non-transitory computer-readable storage medium for use by or in connection with an instruction execution system, apparatus, or device, such as a electronic computer-based system, processor-containing system, or other system that may selectively fetch the instructions from the instruction execution system, apparatus, or device and execute the instructions. In the context of this document, computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access, i.e., volatile, memory (electronic); a read-only memory (electronic); an erasable programmable read only memory such as, for example, Flash memory (electronic); a compact disc memory such as, for example, CD-ROM, CD-R, CD-RW (optical); and digital versatile disc memory, i.e., DVD (optical).

It will also be understood that receiving and transmitting of signals or data as used in this document means that two or more systems, devices, components, modules, or sub-modules are capable of communicating with each other via signals that travel over some type of signal path. The signals may be communication, power, data, or energy signals, which may communicate information, power, or energy from a first system, device, component, module, or sub-module to a second system, device, component, module, or sub-module along a signal path between the first and second system, device, component, module, or sub-module. The signal paths may include physical, electrical, magnetic, electromagnetic, electrochemical, optical, wired, or wireless connections. The signal paths may also include additional systems, devices, components, modules, or sub-modules between the first and second system, device, component, module, or sub-module.

### INDUSTRIAL APPLICABILITY

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Numerous modifications to the present disclosure will be apparent to those skilled in the art in view of the foregoing description. It should be understood that the illustrated embodiments are exemplary only, and should not be taken as limiting the scope of the disclosure.

We claim:

1. A system to facilitate information exchange between a first computer, a first data source operating on a second computer, and a second data source operating on a third computer, the system comprises:
a browser operating on the first computer, wherein the browser receives, from the first data source, data that encodes information to render on the first computer in a first graphical window; and
an extension associated with the browser and operating on the first computer that automatically parses the data to extract an electronic mail address from the data and displays the electronic mail address in a second graphical window on the first computer;
wherein extension sends the electronic mail address to the second data source, and the second and third computers do not directly communicate with one another.

2. The system of claim 1, wherein the extension receives from the second data source status regarding an action undertaken by the second data source in response to the electronic mail address sent thereto.

3. The system of claim 1, wherein the second data source automatically transmits an electronic mail message to the electronic mail address.

4. The system of claim 3, wherein the information comprises first information and the extension displays in the second graphical window second information received in response to transmission of the electronic mail message.

5. The system of claim 4, wherein the extension receives an input from an input device associated with the first computer, and in response renders on the first computer in a third graphical window the second information.

6. The system of claim 5, wherein the second information includes a video.

7. The system of claim 1, wherein in response to receiving the electronic mail address, the second data source transmits to the extension additional data associated with the electronic mail address, and the extension renders the additional data in the second graphical window.

8. The system of claim 1, wherein the second data source includes a database, the extension receives input from an input device associated with first computer, and in response to receiving the input, the extension causes the second data source to create an entry in the database.

9. A method to facilitate information exchange between a first computer, a first data source operating on a second computer, and a second data source operating on a third, the method comprises the steps of:
receiving at the first computer, from the first data source, data that encodes information to render on the first computer in a first graphical window; and
automatically parsing the data by the first computer to extract an electronic mail address from the data;
displaying the electronic mail address in a second graphical window on the first computer;
sending the electronic mail address to the second data source;
wherein the second and third computers do not directly communicate with one another.

10. The method of claim 9, further including automatically receiving by the first computer from the second data source status regarding an action undertaken by the second data source in response to the electronic mail address sent thereto.

11. The method of claim 9, further including transmitting by the second data source an electronic mail message to the electronic mail address.

12. The method claim 11, wherein the information comprises first information and further including receiving by the first computer second information in response to the transmitting of the electronic message and displaying of the second information in the second graphical window.

13. The method of claim 12, further including receiving an input from an input device associated with the first computer, and in response rendering on the first computer in a third graphical window the second information.

14. The method of claim 13, wherein the second information is a video.

15. The method of claim 1, further including in response to receiving the electronic mail address, transmitting by the second data source to the first computer additional data associated with the electronic mail address, and rendering the additional data in the second graphical window.

16. The method of claim 1, wherein the second data source includes a database, further including receiving an input from an input device associated with the first computer, and in response to receiving the input, causing the second data source to create an entry in the database.
